(19) United States
(12) Patent Application Publication
(10) Pub. No.: US 2007/0188624 A1
(43) Pub. Date: Aug. 16, 2007

(54) IMAGE CAPTURING METHOD AND IMAGE-CAPTURING DEVICE THEREOF

(75) Inventor: Zhi-Hai Zhang, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/671,003

(22) Filed: Feb. 5, 2007

(30) Foreign Application Priority Data
Feb. 13, 2006 (TW) 95104771

(51) Int. Cl. H04N 5/228

(52) U.S. Cl. 348/222.1

(57) ABSTRACT

An image capturing method and an image-capturing device thereof are provided. Firstly, a dividing rule for dividing a first part and a second part is set, such that the positions and sizes of the first and the second parts are obtained accordingly. Next, a first resolution corresponding to the first part and a second resolution corresponding to the second part are set respectively. Then, the positions and sizes of the first and the second parts, the first resolution and the second resolution are recorded in a reference table. Next, an image of an object is captured to obtain a multi-resolution analog signal. Then, the multi-resolution analog signal is transformed to a multi-resolution digital signal. After that, a first part image corresponding to the first part and a second part image corresponding to the second part are respectively obtained with reference to the multi-resolution digital signal.

This application claims the benefit of Taiwan application Serial No. 095104771, filed Feb. 13, 2006, the subject matter of which is incorporated herein by reference.

### BACKGROUND OF THE INVENTION

1. Field of the Invention

The invention relates in general to an image capturing method and an image-capturing device thereof, and more particularly to an image capturing method for capturing and storing different parts of an image according to different resolution levels and an image-capturing device thereof.

2. Description of the Related Art

The technology of digital image has gained rapid advance. The digital image has the advantages of long-term preservation and small storage space, and is compactable with various features of image processing. Thus, the application of digital image is now widely used in business and everydayness.

Let a scanner be taken for example. A conventional scanner captures and stores a whole image according to a fixed resolution level. The image can be compressed and stored at an image compression ratio according to an image compression algorithm. There are many image compression algorithms available nowadays, and the formats of the algorithm include JPG, BMP and Tiff.

When the user may only be interested in a partial region of the whole image, the user may not require the whole image to have resolution level. Under such circumstances, only the partial region needs to have higher resolution level. However, the conventional scanner can only capture the whole image at the same resolution level, and then store the image using the same image compression algorithm and the same image compression ratio. Thus, in order to satisfy the requirement that a partial region may have higher resolution level, the user has to capture the whole image at a higher resolution level and then compress the image according to the same image compression algorithm and the same compression ratio. When an image is captured at a higher resolution level, not only more storage space is required, but also the efficiency in image processing is decreased and slowed down.

Moreover, the same problem occurs to the image-capturing device of other digital camera or digital video recorder. Therefore, how to increase the efficiency of image capturing has become an imminent issue in image capturing technology.

### SUMMARY OF THE INVENTION

It is therefore an object of the invention to provide an image capturing method and an image-capturing device thereof. According to the invention, an image is divided into several parts with different resolution levels, a photo-sensing element is used to obtain a multi-resolution analog signal, then the procedures of compression, storage, decompression and outputting are applied to the parts with different resolution levels, such that the image is compressed and stored in a most effective way. The user can selectively capture and store the part of interest at a higher resolution level, and capture the part not of interest at a lower resolution level, not only largely reducing the memory space required for the storage of the image, but also maintaining the image quality.

The invention achieves the above-identified object by providing an image capturing method for capturing the image of an object. Firstly, a dividing rule for dividing a first part and a second part is set, such that the positions and sizes of the first part and the second part are obtained accordingly. Next, a first resolution corresponding to the first part and a second resolution corresponding to the second part are set respectively. Then, the positions and sizes of the first and the second parts, the first resolution and the second resolution are recorded in a reference table. Next, an image of an object is captured to obtain a multi-resolution analog signal. Then, the multi-resolution analog signal is transformed to a multi-resolution digital signal. After that, a first part image corresponding to the first part and a second part image corresponding to the second part are respectively obtained with reference to the multi-resolution digital signal.

The invention achieves another object by providing an image-capturing device. The image-capturing device comprises a setting unit, a storage unit, a photo-sensing element and a processing unit. The setting unit comprises a rule-setting interface and a parameter-setting interface. The rule-setting interface is for setting a dividing rule for dividing a first part and a second part to obtain the positions and sizes of the first and the second parts. The parameter-setting interface is for setting a first resolution corresponding to the first part and a second resolution corresponding to the second part. The contents of the storage unit comprise a reference table for recording the first resolution, the second resolution, the size and position of the first and the second parts. The photo-sensing element is for capturing an image of an object to obtain a multi-resolution analog signal. The processing unit comprises a signal transformation unit and a data processing unit. The signal transformation unit is for transforming the multi-resolution analog signal to a multi-resolution digital signal. The data processing unit is for obtaining a first part image corresponding to the first part and a second part image corresponding to the second part with reference to the multi-resolution digital signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flowchart of an image capturing method according to a first embodiment of the invention;

FIG. 2 is a block diagram of an image-capturing device according to the first embodiment of the invention;

FIG. 3 is a perspective of the first to the fifth parts;

FIG. 4 illustrates the contents stored in the storage unit of FIG. 2;

FIG. 5A˜5E are perspectives of the first to the fifth part images;

FIG. 6 is a flowchart of an image compressing, storing, decompressing and outputting method according to the first embodiment of the invention;

FIGS. 7A˜7E are perspectives of the first to the fifth resolution images;

FIG. 8 shows the branch layer relationship of the first to the fifth resolution images according to the first embodiment of the invention;

FIG. 9 is a block diagram of an image-capturing device according to a second embodiment of the invention; and

FIG. 10 is a diagram of a multi-resolution analog signal along the scan line 10-10′ of FIG. 3.

### DETAILED DESCRIPTION OF THE INVENTION

### First Embodiment

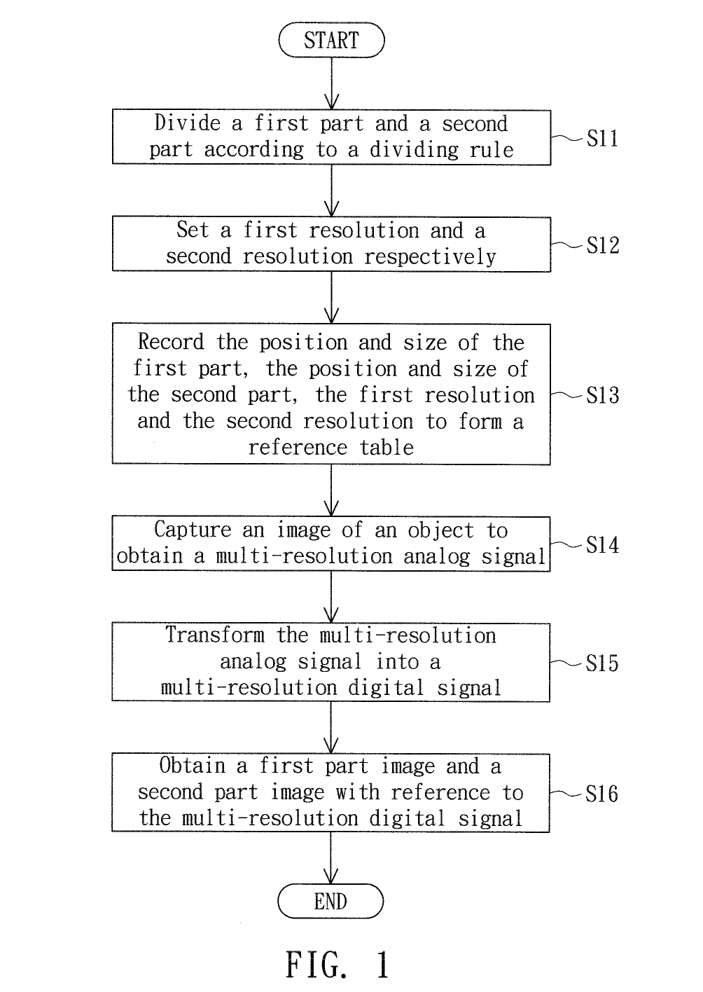

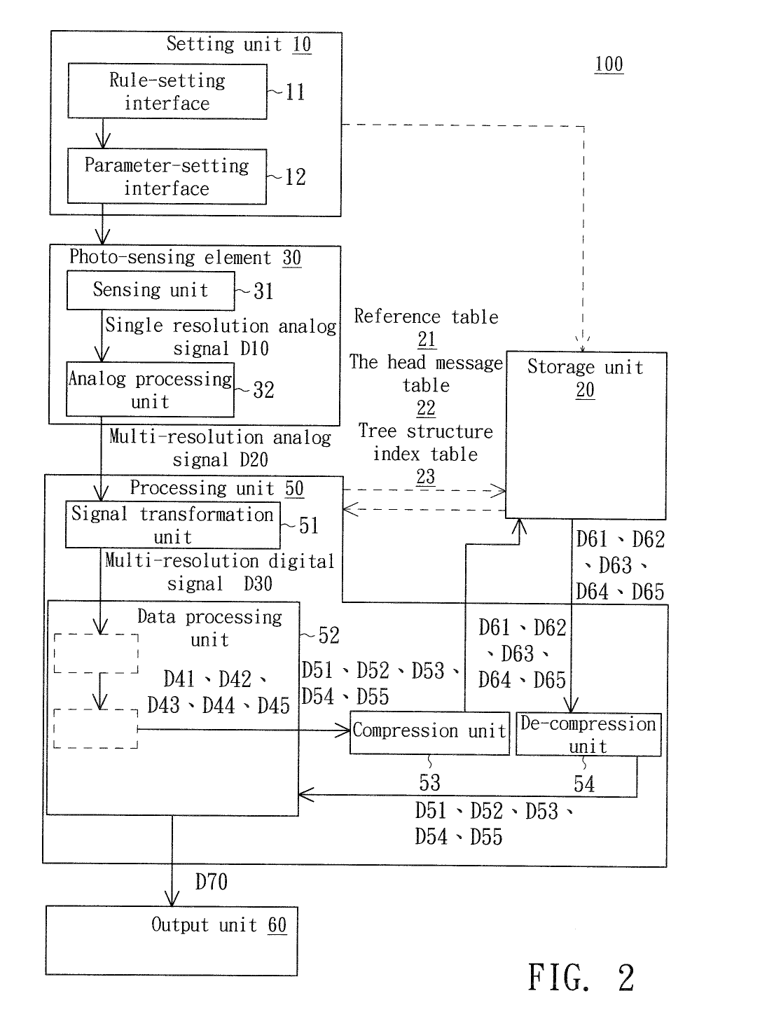

Referring to both FIGS. 1˜2. FIG. 1 is a flowchart of an image capturing method according to a first embodiment of the invention. FIG. 2 is a block diagram of an image-capturing device according to the first embodiment of the invention. The image-capturing device 100 of the present embodiment of the invention is exemplified by a scanner. As indicated in FIG. 2, the image-capturing device 100 comprises a setting unit 10, a photo-sensing element 30, a processing unit 50 and a storage unit 20. The setting unit 10 comprises a rule-setting interface 11 and a parameter-setting interface 12. The photo-sensing element 30 comprises a sensing unit 31 and an analog processing unit 32. The processing unit 50 comprises a signal transformation unit 51, a data processing unit 52, a compression unit 53 and a decompression unit 54.

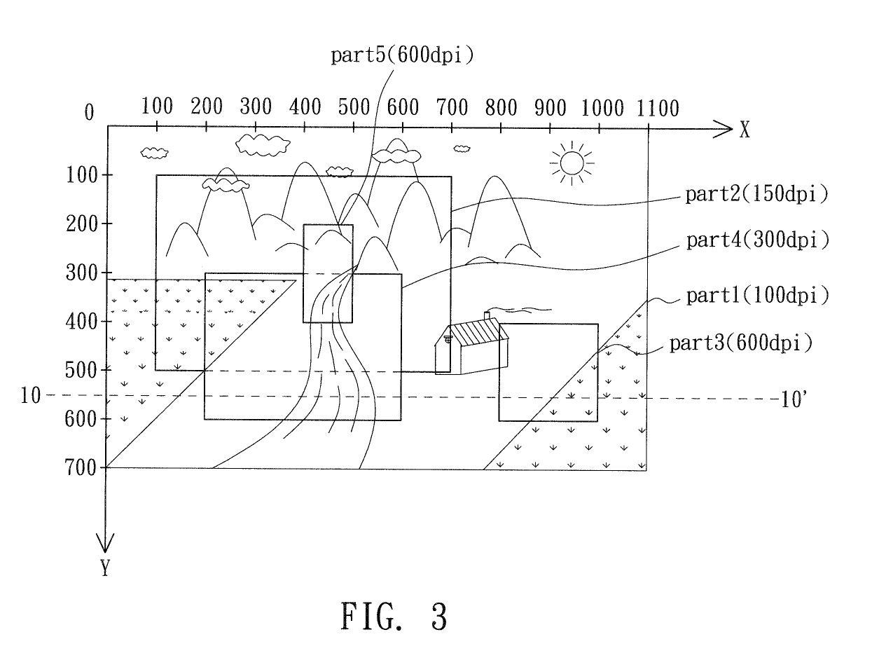

Firstly, the method begins at step S11 of FIG. 1, and also refers to FIG. 3. FIG. 3 is a perspective of the first to the fifth parts. In the step S11, a dividing rule for dividing at least a first part and a second part is set by the user. The present embodiment of the invention is exemplified by a first part part1, a second part part2, a third part part3, a fourth part part4 and a fifth part part5. The user uses a rule-setting interface 11 to set a dividing rule for dividing a first part part1, a second part part2, a third part part3, a fourth part part4 and a fifth part part5. The first part part1 to the fifth part part5 can be divided by a pre-view interface or a select interface. The pre-view interface is for dividing the first part part1 to the fifth part part5 directly. The select interface is for selecting a programming algorithm to divide the first part part1 to the fifth part part5. Thus, the positions and sizes of the first part part1 to the fifth part part5 are obtained accordingly. In the present embodiment of the invention, the first part part1 is a region whose starting point is (0,0) and size equal to 1100×700. The second part part2 is a region whose starting point is (100,100) and size equal to 600×400. The third part part3 is a region whose starting point is (800,400) and size equal to 200×200 region. The fourth part part4 is a region whose starting point is (200,300) and size equal to 400×300. The fifth part part5 a region whose starting point is (400,200) and size equal to 100×200.

Next, the method proceeds to step S12 of FIG. 1 to set at least a first resolution and a second resolution respectively. In the present embodiment of the invention, a first resolution to a fifth resolution are set by the user using a parameter-setting interface 12. The first resolution to the fifth resolution respectively correspond to the resolution of the first part part1 to the resolution of the fifth part part5 of FIG. 3. The first resolution to the fifth resolution are exemplified by the resolution level of 100 dpi, 150 dpi, 600 dpi, 300 dpi and 600 dpi, respectively.

The interface of the setting unit 10 can be a display monitor, a touch screen, a hand-writing screen, a key pad, a mouse or a combination thereof. Alternatively, other units of the image-capturing device 100 such as the display unit for example can be combinded with an interface for the setting unit 10. Other types of the interface of the setting unit, parameter setting unit and rule-setting interface can be found in current applications, and the exemplification of the present embodiment is not for limiting the scope of technology of the invention.

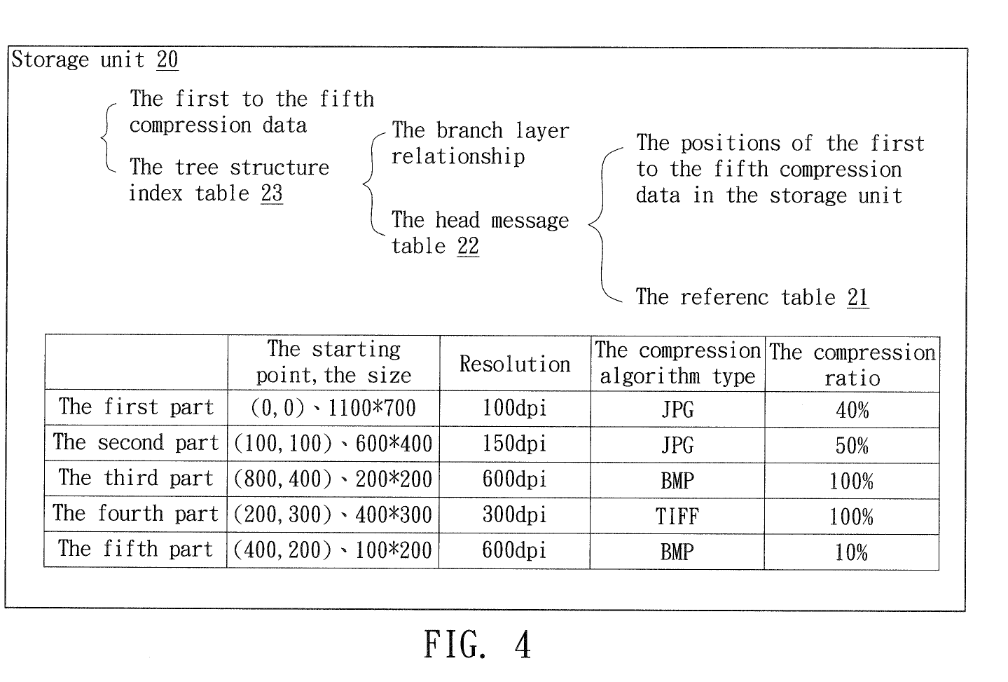

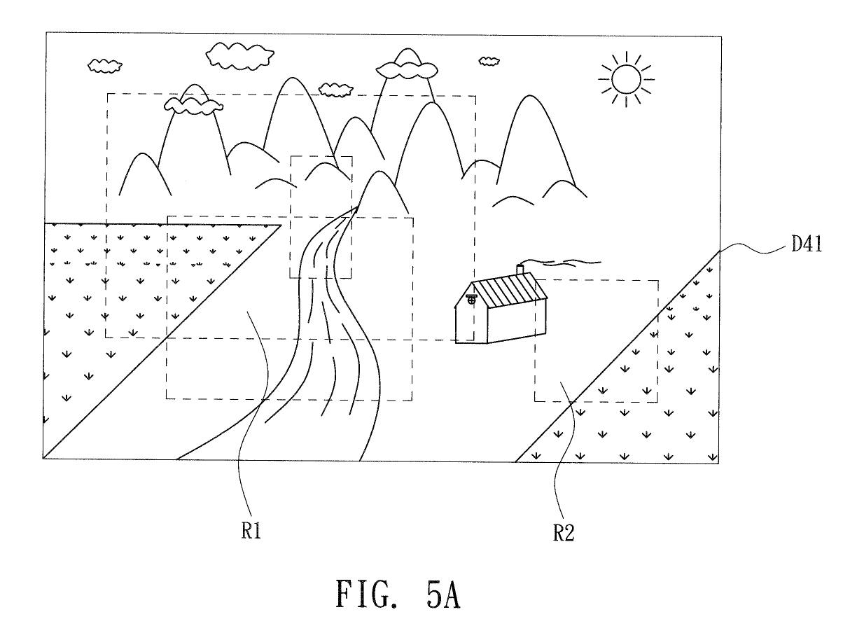

Then, the method proceeds to step S13 of FIG. 1, and also refers to FIG. 4. FIG. 4 illustrates the contents stored in the storage unit of FIG. 2. At least the position and size of the first part, the position and size of the second part, the first resolution and the second resolution are recorded to form a reference table. In the present embodiment of the invention, the positions and sizes of the first part part1 to the fifth part part5 as well as the first resolution to the fifth resolution are recorded in a reference table 21.

Next, the method proceeds to step S14 of FIG. 1, and also refers to FIG. 2. The sensing unit 31 is used to capture an image of an object to obtain a multi-resolution analog signal D20.

In the present embodiment of the invention, the step S15 further includes several sub-steps. First, the sensing unit 31 capture the image of the object to obtain a signal resolution analog signal D10. Then, the signal resolution analog signal D10 is processed into the multi-resolution analog signal D20 with reference to the reference table 21.

Then, the method proceeds to step S15 of FIG. 1. The signal transformation unit 51 is used to transform the multi-resolution analog signal D20 into a multi-resolution digital signal D30, wherein the digital signal is a grey scale.

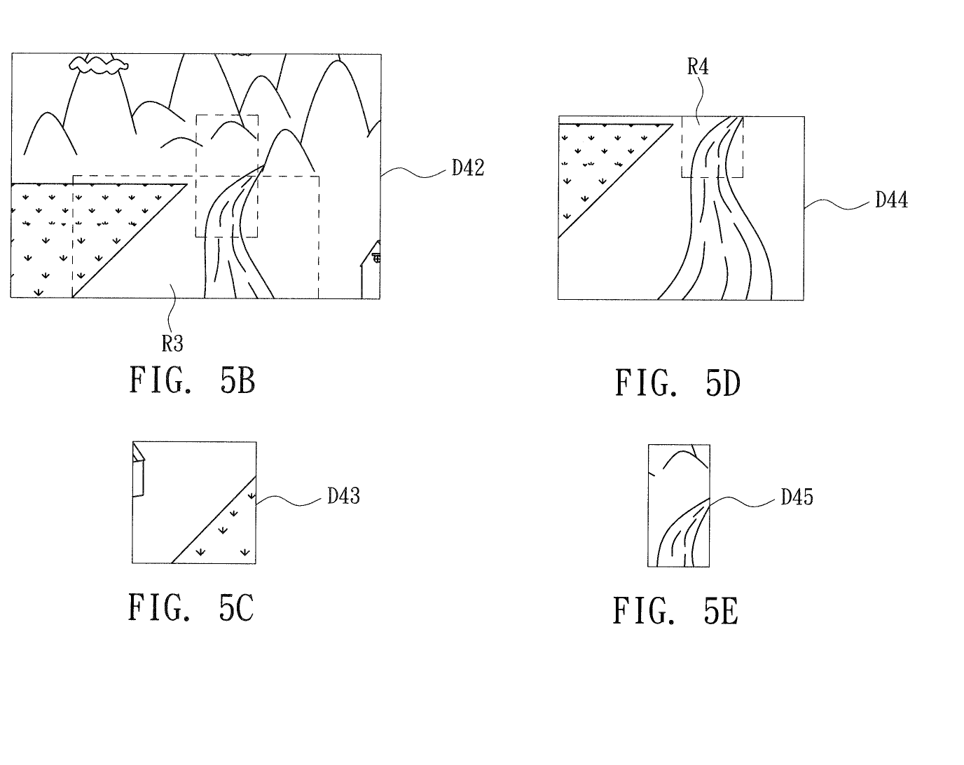

Next, the method proceeds to step S16 of FIG. 1, and also refers to FIG. 5A˜5E. FIG. 5A˜5E are perspectives of the first to the fifth part images. At least a first part image and a second part image are obtained with reference to the multi-resolution digital signal. In the present embodiment of the invention, the data processing unit 52 obtains a first part image D41 to a fifth part image D45 with reference to the multi-resolution digital signal D30. The first part image D41 to the fifth part image D45 respectively correspond to the first part part1 to the fifth part part5.

The first part image D41 to the fifth part image D45 respectively correspond to the resolution levels required by the user. When the subsequent image processing of the first part image D41 to the fifth part image D45 is processed, there is no need to process the whole image at high resolution level, largely reducing data volume in system processing. The procedures of the subsequent image processing are elaborated below.

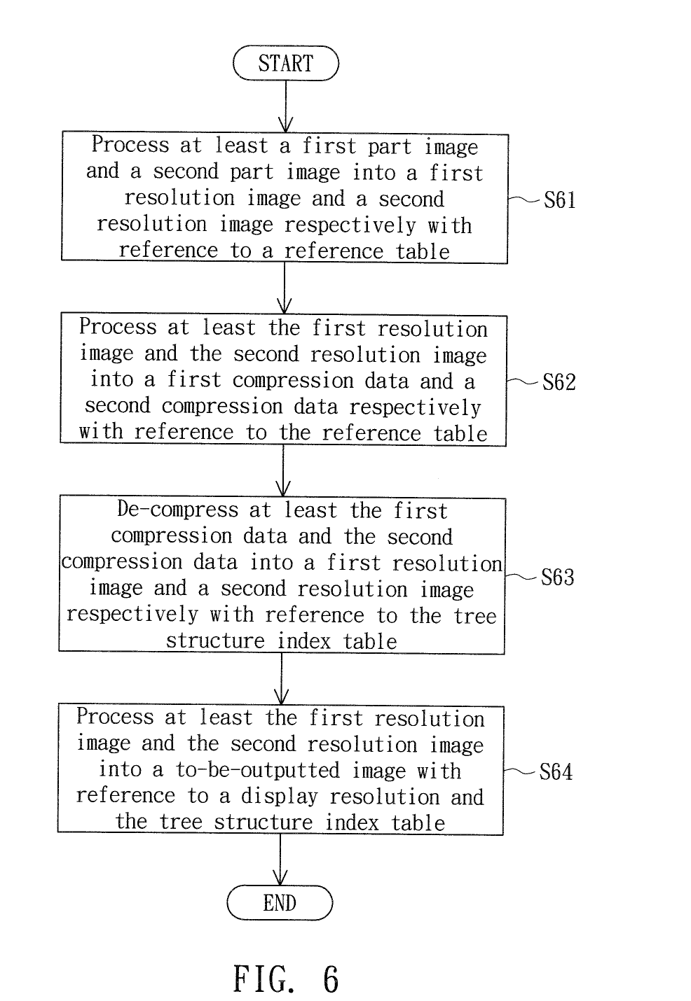

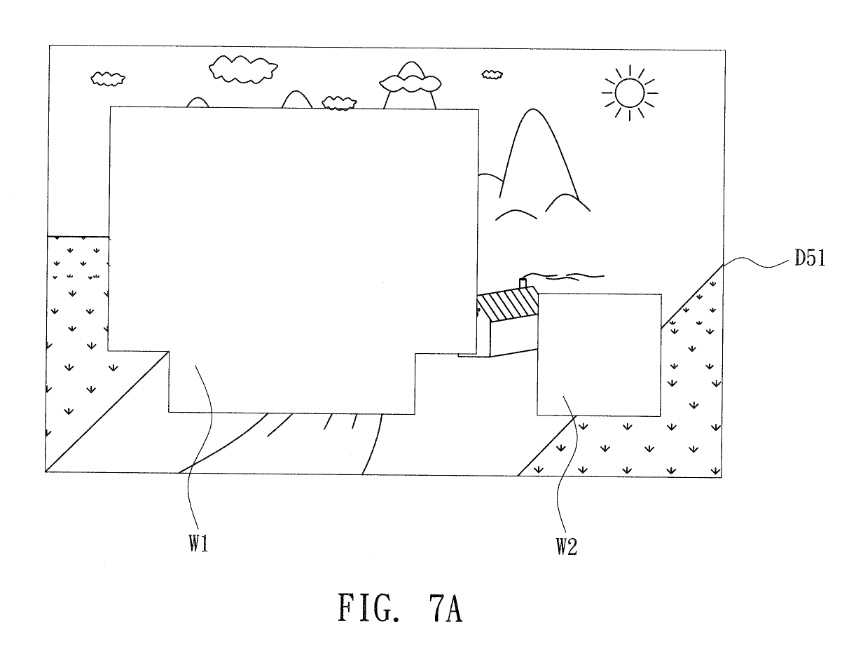

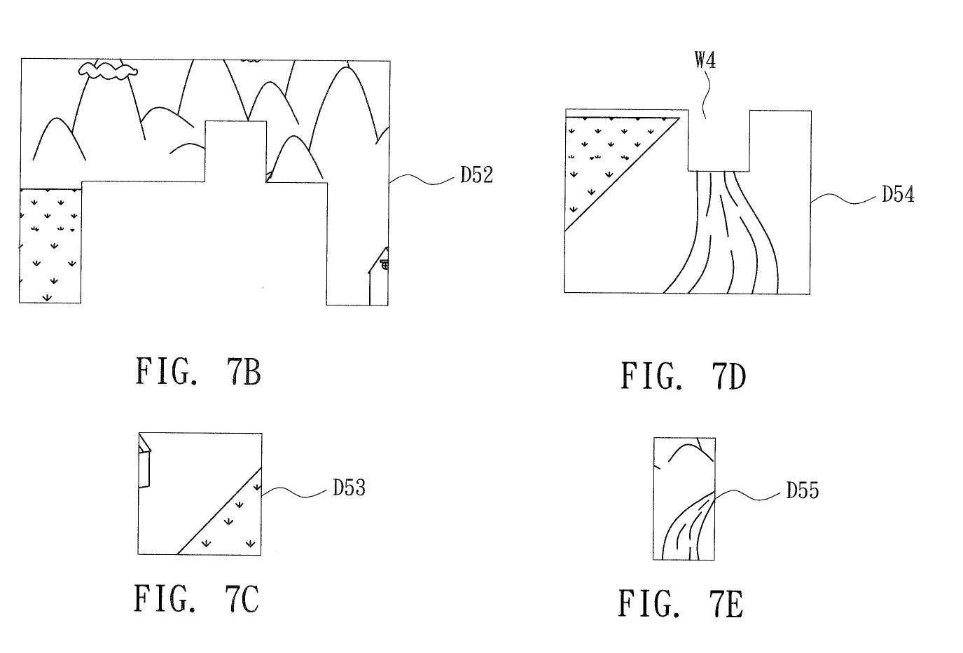

Referring to both FIG. 6 and FIG. 2. FIG. 6 is a flowchart of an image compressing, storing, decompressing and outputting method according to the first embodiment of the invention. The method proceeds to step S61 of FIG. 6, and also refers to FIGS. 7A˜7E. FIGS. 7A˜7E are perspectives of the first to the fifth resolution images. At least the first part image and the second part image are respectively processes into a first resolution image and a second resolution image with reference to the reference table. If the first part and the second part have an overlapping part and the first resolution is smaller than second resolution, then the first part image is processed into a first resolution image and the second part image is processed into a second resolution image and the first resolution image has a blank part corresponding to the overlapping part. If the first part and the second part are not overlapping, then the first resolution image is equal to the first part image.

In the present embodiment of the invention, the first part image D41 to the fifth part image D45 are respectively processed into a first resolution image D51, a second resolution image D52, a third resolution image D53, a fourth resolution image D54 and a fifth resolution image D55 by the data processing unit 52 with reference to the reference table 21.

The first part image D41 of FIG. 5A has two overlapping parts R1 and R2 overlapped with the second part image D42 to the fifth part image D45, and the first resolution (100 dpi) is lower than the second resolution to the fifth resolution (150 dpi˜600 dpi). The first part image D41 is processed into a first resolution image D51 by the data processing unit 52 with reference to the reference table 21. As indicated in FIG. 7A, the first resolution image D51 has two blank parts W1 and W2 respectively corresponding to the two overlapping parts R1 and R2. By enabling the blank parts to correspond to the overlapping parts, the data volume to be stored is largely reduced, hence increasing data processing speed.

The second part image D42 of FIG. 5B has an overlapping part R3 overlapped with the fourth part image D44 and the fifth part image D45, and the second resolution (150 dpi) is lower than the fourth resolution (300 dpi) and the fifth resolution (600 dpi). The second part image D42 is processed into a second resolution image D52 by the data processing unit 52 with reference to the reference table 21. As indicated in FIG. 7B, the second resolution image D52 has a blank part W3 corresponding to the overlapping part R3.

The third resolution (600 dpi) of the third part image D43 of FIG. 5C is higher than the first resolution (100 dpi) of the first part image D41 overlapped with the third part image D43. The third part image D43 is processed into a third resolution image D53 by the data processing unit 52 with reference to the reference table 21.

The fourth part image D44 of FIG. 5D has an overlapping part R4 overlapped with the fifth part image D45, and the fourth resolution (300 dpi) is lower than the fifth resolution (600 dpi). The fourth part image D44 is processed into a fourth resolution image D54 by the data processing unit 52 with reference to the reference table 21. As indicated in FIG. 7D, the fourth resolution image D54 has a blank part W4 corresponding to the overlapping part R4.

The third resolution (600 dpi) of the fifth part image D45 of FIG. 5E is higher than the resolution (100 dpi˜300 dpi) of the part images D41, D42 and D44 overlapped with the fifth part image D45. The fifth part image D45 is processed into a fifth resolution image D55 by the data processing unit 52 with reference to the reference table 21.

Next, the method proceeds to step S62 of FIG. 6, and also refers to FIG. 2. At least a first resolution image and a second resolution image are respectively processed into a first compression data and a second compression data with reference to the reference table. In the present embodiment of the invention, the first resolution image D51 to the fifth resolution image D55 are respectively processed by the compression unit 53 with reference to the reference table 21 to obtain a first compression data D61 to a fifth compression data D65.

As indicated in FIG. 4, the reference table 21 further comprises a first compression algorithm type to a fifth compression algorithm type and a first compression ratio to a fifth compression ratio. The first compression algorithm to the fifth compression algorithm as well as the first compression ratio to the fifth compression ratio correspond to the first resolution image D51 to the fifth resolution image D55, respectively. In the present embodiment of the invention, the respective formats of the compression algorithm type of the first resolution image D51 to the fifth resolution image are JPG, JPG, BMP, Tiff and BMP, and the compression ratios are respectively equal to 40%, 50%, 100%, 100% and 10%.

As indicated in FIG. 2 and FIG. 4, the first compression data D61 to the fifth compression data D65 are stored in the storage unit 20. Meanwhile, a head message table 22 is created in the storage unit 20. The head message table 22 comprises a reference table 21 and the positions of the first compression data D61 to the fifth compression data D65 in the storage unit 20. The head message table 22 also comprises the sizes and positions of the overlapping parts R1˜R4. The sizes and positions of the overlapping parts R1˜R4 can be obtained from the calculation of the sizes and positions of the first part part1 to the fifth part part5, and are stored in the head message table 22, such that there is no need to calculate again when the image is outputted. Consequently, the efficiency is increased.

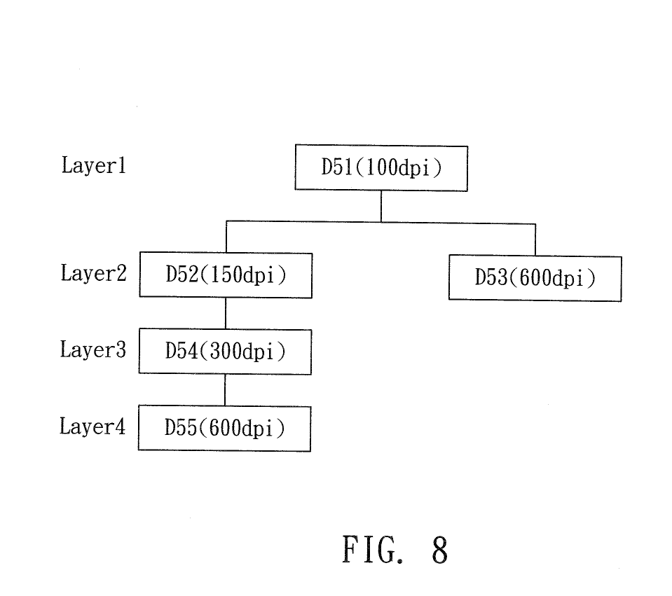

Referring to FIG. 8, the branch layer relationship of the first to the fifth resolution images according to the first embodiment of the invention is shown. There is a branch layer relationship existing between the first resolution image D51 to the fifth resolution image D55. Let a first part and a second part be taken for example. If the first part and the second part have an overlapping part and the first resolution is smaller than second resolution, then both the first resolution image and the second resolution image belong to the same branch but the layer of the first resolution image is higher or lower than the layer of the second resolution image. If the first part and the second part are not overlapped with each other, then the first resolution image and the second resolution image belong to different branches. In the present embodiment of the invention, the first resolution image D51, the second resolution image D52, the fourth resolution image D54 and the fifth resolution image D55 all belong to the same branch, and the layer of the first resolution image D51, the second resolution image D52, the fourth resolution image D54 and the fifth resolution image D55 are in the order of Layer1, Layer2, Layer3 and Layer4. Both the first resolution image D51 and the third resolution image D53 belong to the same branch, and the layer of the third resolution image D53 is Layer2.

The branch layer relationship of the first resolution image D51 to the fifth resolution image D55 forms a tree structure index table 23. The tree structure index table 23 comprises the head message table 22 and the branch layer relationship of the first resolution image D51 to the fifth resolution image D55.

Next, the method proceeds to step S63 of FIG. 6. At least a first compression data and a second compression data are respectively decompressed into a first resolution image and a second resolution image with reference to the tree structure index table. In the present embodiment of the invention, the first compression data D61 to the fifth compression data D65 stored in the storage unit 20 are respectively decompressed into the first resolution image D51, the second resolution image D52, the third resolution image D53, the fourth resolution image D54 and the fifth resolution image D55 by the decompression unit 54 with reference to the tree structure index table 23

Then, the method proceeds to step S64 of FIG. 6, and also refers to FIG. 2. The image-capturing device 100 further comprises an output unit 60. At least a first resolution image and a second resolution image are processed into a to-be-outputted image with reference to a display resolution and a tree structure index table. In the present embodiment of the invention, the first resolution image D51 to the fifth resolution image D55 are processed by the data processing unit 42 with reference to the display resolution 300 dpi and the tree structure index table 23. The blank message of the blank parts W1, W2, W3 and W4 are respectively replaced by useful image message in the corresponding positions of the second resolution image D52, the third resolution image D53, the fourth resolution image D54 and the fifth resolution image D55, such that a to-be-outputted image D70 is formed. Next, the to-be-outputted image D70 is outputted by the output unit 60.

Examples of the output unit 60 include a printer, a display monitor, a facsimile machine or a multi-function machine. It is noted that the types of output unit exemplified in the present embodiment are not for limiting the scope of technology of the invention.

### Second Embodiment

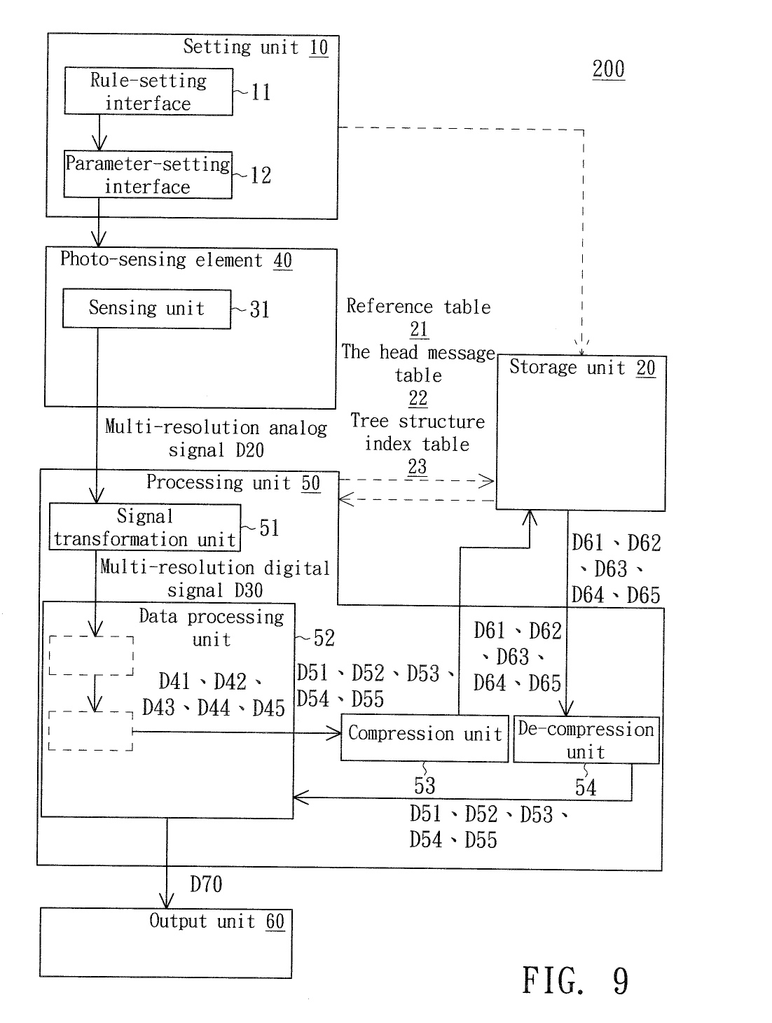

Referring to FIG. 9, a block diagram of an image-capturing device according to a second embodiment of the invention is shown. The image capturing method of the present embodiment of the invention and the image-capturing device 200 thereof differ with the image capturing method of the first embodiment and the image-capturing device 100 thereof in the photo-sensing element 40 and the method of obtaining the multi-resolution analog signal D20. As for the similar elements, the same reference numbers are used and are not repeated here.

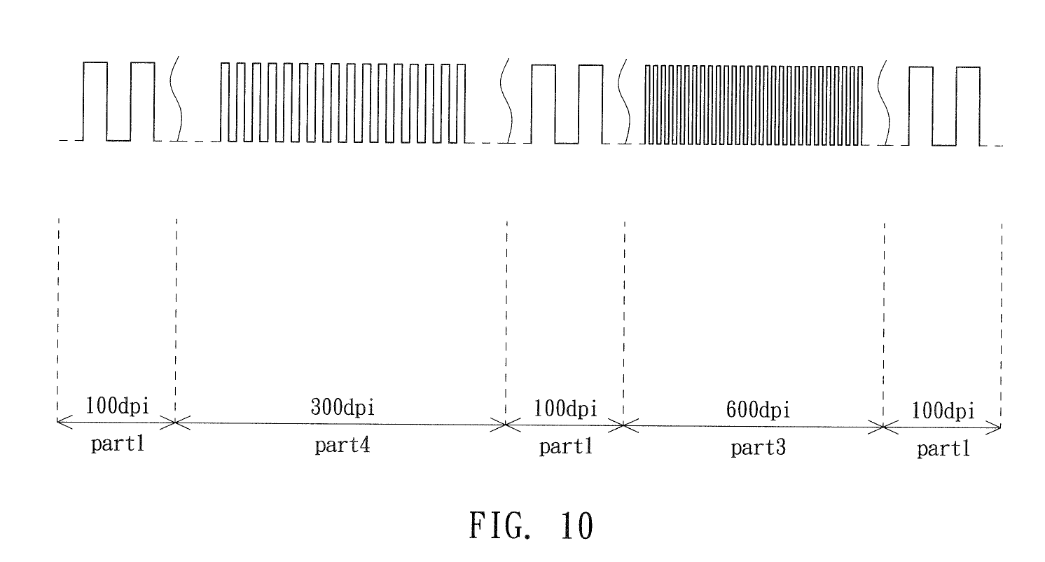

The photo-sensing element 40 of the present embodiment of the invention supports multi-resolution signal scanning function. Referring to both FIG. 3 and FIG. 10. FIG. 10 is a diagram of a multi-resolution analog signal along the scan line 10-10′ of FIG. 3. In FIG. 3, the scan line 10-10′ sequentially passes through the first part part1, the fourth part part4, the first part part1, the third part part3 and the first part part1. As indicated in FIG. 10, the photo-sensing element 40 controls the sensing unit 31 to output an analog signal with reference to the resolution levels of 100 dpi, 300 dpi, 100 dpi, 600 dpi and 100 dpi corresponding to the parts on the scan line 10-10′.

As indicated in FIG. 9, the photo-sensing element 40 outputs a multi-resolution analog signal D20 after the completion of scanning. After that, the procedures of image processing, compressing, storing, decompressing or outputting are sequentially performed according to the first embodiment, and are not repeated here.

According to the above two embodiments, the image-capturing device of the invention is exemplified by a scanner, however, the image-capturing device of the invention can be a digital camera or a digital video recorder. The digital camera can capture a single image of an object by taking a photo, or the digital video recorder can capture continuous single images of an object to obtain a dynamic frame. Any designs satisfying user's needs of providing different resolution levels to different parts according to the steps of setting several parts of an image to have different resolution levels, obtaining a multi-resolution analog signal by a photo-sensing element, and performing the procedures of compressing, storing, decompressing and outputting to the parts with different resolution levels are within the scope of technology of the invention.

According to the above two embodiments, the image-capturing device of the invention is exemplified by a built-in setting unit and a built-in output unit. However, the image-capturing device of the invention can be connected to the external setting unit and output unit via a linking port without using a built-in setting unit and a built-in output unit. The use of any types of setting units and output units is within the scope of technology of the invention.

According to the image capturing method and image-capturing device thereof disclosed in the above embodiments of the invention, an image is divided into several parts with different resolution levels, a photo-sensing element is used to obtain a multi-resolution analog signal, then the procedures of compressing, storing, decompressing and outputting are applied to the parts with different resolution levels, such that the image is compressed and stored in most effectively way. The user can selectively capture and store the part of interest at a higher resolution level, and capture the part not of interest at a lower resolution level, not only largely reducing the memory space required for the storage of the image, but also maintaining the image quality at the same time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image capturing method for capturing the image of an object, the method comprising:
setting a dividing rule for dividing a first part and a second part to obtain the positions and sizes of the first part and the second part accordingly;
setting a first resolution and a second resolution respectively corresponding to the first part and the second part;
recording the positions and sizes of the first and the second parts, and the first resolution and the second resolution in a reference table;
capturing the image of an object to obtain a multi-resolution analog signal;
transforming the multi-resolution analog signal into a multi-resolution digital signal; and
obtaining a first part image and a second part image respectively corresponding to the first part and the second part with reference to the multi-resolution digital signal.

2. The image capturing method according to claim 1, wherein the dividing rule comprises:
dividing the first part and the second part in a pre-view interface directly.

3. The image capturing method according to claim 1, wherein the dividing rule comprises:
selecting a programming algorithm in a select interface; and
dividing the first part and the second part by the programming algorithm.

4. The image capturing method according to claim 1, wherein the step of capturing the image of the object further comprises:
capturing the image of the object to obtain a single resolution analog signal; and
processing the single resolution analog signal into the multi-resolution analog signal with reference to the reference table.

5. The image capturing method according to claim 1, further comprising:
processing the first part image and the second part image into a first resolution image and a second resolution image respectively with reference to the reference table if the first part and the second part have an overlapping part and the first resolution is lower than second resolution, wherein the first resolution image has a blank part corresponding to the overlapping part; and
determining that the first resolution image is equal to the first part image if the first part and the second part are not overlapped with each other.

6. The image capturing method according to claim 5, wherein the reference table further comprises a first compression algorithm type, a first compression ratio, a second compression algorithm type and a second compression ratio, the first compression algorithm and the first compression ratio correspond to the first resolution image, while the second compression algorithm and the second compression ratio correspond to the second resolution image, the method further comprising:
processing the first resolution image and the second resolution image to obtain a first compression data and a second compression data respectively with reference to the reference table.

7. The image capturing method according to claim 6, the method further comprising:
storing the first compression data and the second compression data in a storage unit and creating a head message table in the storage unit, wherein the head message table comprises the reference table, the position of the first compression data in the storage unit, and the position of the second compression data in the storage unit.

8. The method according to claim 7, further comprising:
determining that the first resolution image and the second resolution image belong to the same branch but the layer of the first resolution image is higher or lower than layer of the second resolution image if the first part and the second part have an overlapping part and the first resolution is smaller than second resolution; and
determining that the first resolution image and the second resolution image belong to different branches if the first part and the second part are not overlapped with each other.

9. The method according to claim 8, further comprising:
storing the branch layer relationship between the first resolution image and the second resolution image to form a tree structure index table, wherein the tree structure index table comprises the head message table and the branch layer relationship between the first resolution image and the second resolution image.

10. The method according to claim 9, further comprising:
decompressing the first compression data and the second compression data stored in the storage unit into the first resolution image and the second resolution image respectively with reference to the tree structure index table.

11. The method according to claim 9, after the step of decompressing the first compression data and the second compression data, the method further comprising:
processing the first resolution image and the second resolution image into a to-be-outputted image with reference to a display resolution and the tree structure index table; and
outputting the to-be-outputted image.

12. The method according to claim 1, wherein the method is for continuously capturing the single image of the object to obtain a dynamic frame.

13. An image-capturing device, comprising:
a setting unit, comprising:
a rule-setting interface for setting a dividing rule for dividing a first part and a second part to obtain the positions and sizes of the first and the second parts, respectively; and
a parameter-setting interface for setting a first resolution corresponding to the first part and a second resolution corresponding to the second part;
a storage unit whose contents comprising:
a reference table for recording the first resolution, the second resolution, and the size and position of the first and the second parts;
a photo-sensing element for capturing the image of an object to obtain a multi-resolution analog signal; and
a processing unit, comprising:
a signal transformation unit for transforming the multi-resolution analog signal into a multi-resolution digital signal; and
a data processing unit for obtaining a first part image and a second part image respectively corresponding to the first part and the second part with reference to the multi-resolution digital signal.

14. The image-capturing device according to claim 13, wherein the photo-sensing element comprises:
a sensing unit; and
an analog processing unit;
wherein, the sensing unit captures the image of an object to obtain a single resolution analog signal, and then the single resolution analog signal is processed into the multi-resolution analog signal by the analog processing unit.

15. The image-capturing device according to claim 13, wherein
the first part image and the second part images are processed into a first resolution image and a second resolution image respectively by the data processing unit with reference to the reference table if the first part and the second part have an overlapping part and the first resolution is lower than the second resolution, the first resolution image has a blank part corresponding to the overlapping part; and
the first resolution image is determined to be equal to the first part image if the first part and the second part are not overlapped with each other.

16. The image-capturing device according to claim 15, wherein the reference table further comprises a first compression algorithm type, a first compression ratio, a second compression algorithm type and a second compression ratio, the first compression algorithm type and the first compression ratio correspond to the first resolution image, while the second compression algorithm and the second compression ratio correspond to the second resolution image, the processing unit further comprising:
a compression unit for processing the first resolution image and the second resolution image to obtain a first compression data and a second compression data respectively with reference to the reference table.

17. The image-capturing device according to claim 15, wherein the contents of the storage unit further comprise:
the first compression data;
the second compression data;
an head message table comprising the reference table, the position of the first compression data in the storage unit, and the position of the second compression data in the storage unit.

18. The image-capturing device according to claim 17, wherein
the first resolution image and the second resolution image are determined to belong to the same branch but the layer of the first resolution image is higher or lower than layer of the second resolution image if the first part and the second part have an overlapping part and the first resolution is smaller than second resolution; and
the first resolution image and the second resolution image are determined to belong to different branches if the first part and the second part are not overlapped with each other.

19. The image-capturing device according to claim 18, wherein the contents of the storage unit further comprise:
a tree structure index table comprising the head message table and the branch layer relationship between the first resolution image and the second resolution image.

20. The image-capturing device according to claim 19, wherein the processing unit further comprises:
a decompression unit for decompressing the first compression data stored in the storage unit and the second compression data stored in the storage unit into the first resolution image and the second resolution image respectively with reference to the tree structure index table; the data processing unit further processes the first resolution image and the second resolution image into a to-be-outputted image with reference to a display resolution and the tree structure index table, the image-capturing device further comprising:
an output unit for outputting the to-be-outputted image.
